(19) United States
(12) Patent Application Publication
(10) Pub. No.: US 2008/0042992 A1
(43) Pub. Date: Feb. 21, 2008

(54) Touch screen display apparatus and method fof driving the same

(75) Inventor: Tae-Woo Kim, Seongnam-si (KR)

Correspondence Address: MILLS & ONELLO LLP, ELEVEN BEACON STREET, SUITE 605, BOSTON, MA, 02108, US

(73) Assignee: Samsung Electronics, Co., Ltd., Suwon-si (KR)

(21) Appl. No.: 11/893,394

(22) Filed: Aug. 16, 2007

(30) Foreign Application Priority Data
Aug. 18, 2006 (KR) 10-2006-0077941

(51) Int. Cl. G06F 3/041

(52) U.S. Cl. 345/173

(57) ABSTRACT

A touch screen display apparatus includes a touch screen panel, a driver circuit unit, and a hybrid touch screen panel controller. The touch screen panel includes first and second screen regions that provide first and second analog sensing signals when respective touch events occur in the first and second screen regions. The driver circuit unit includes first and second driver circuits that respectively convert the first and second analog sensing signals to first and second digital sensing data. The hybrid touch screen panel controller determines one touch position in the touch screen panel based on the first and second digital sensing data.

### CROSS-REFERENCE TO RELATED APPLICATIONS

This application claims priority under 35 USC § 119 to Korean Patent Application No. 10-2006-0077941, filed on Aug. 18, 2006 in the Korean Intellectual Property Office (KIPO), the disclosure of which is incorporated herein in its entirety by reference.

### BACKGROUND OF THE INVENTION

1. Field of the Invention

The present invention relates to a display apparatus, and more particularly to a touch screen display apparatus and a method of driving the touch screen display apparatus.

2. Description of the Related Art

A touch screen display device is a system where corresponding coordinates are recognized when a pen or a finger is touched on a touch screen panel.

In a conventional touch screen system, a controller processes sensing data from one display driver integrated circuit (DDI). Therefore, the controller cannot perform the processing operation, when more than two sensing data is transmitted in parallel to the controller. In addition, in a conventional touch screen system, the controller cannot be employed when a panel size or a resolution is changed because the sensing data is serially transmitted to the controller. Furthermore, power consumption increases because data of an unnecessary region is processed when a touch position is detected, and data processing time increases because of serial data transmission.

Accordingly, there is a need for a touch screen system capable of parallel-processing more than two sensing data.

### SUMMARY OF THE INVENTION

Provided is a touch screen display apparatus that includes a hybrid touch screen panel controller capable of parallel-processing two sensing data.

Also provided is a multiple touch screen display apparatus that includes a multiple controller capable of parallel-processing a plurality of sensing data.

Also provided is a method of driving the touch screen display apparatus that includes a hybrid touch screen panel controller capable of parallel-processing two sensing data.

In accordance with one aspect of the present invention, there is provided a touch screen display apparatus that includes a touch screen panel, a driver circuit unit, and a hybrid touch screen panel controller. The touch screen panel includes first and second screen regions configured to provide first and second analog sensing signals when respective touch events occur in the first and second screen regions. The driver circuit unit includes first and second driver circuits configured to respectively convert the first and second analog sensing signals to first and second digital sensing data. The hybrid touch screen panel controller is configured to determine one touch position of one of the touch events in the touch screen panel based on the first and second digital sensing data.

The first and second analog sensing signals can correspond to a voltage value associated with respective positions in the touch screen panel where the touch events occurred.

The touch screen panel can includes at least one frame unit configured to provide the first and second analog sensing signals to the driver circuit unit.

The hybrid touch screen panel controller can include a frame memory unit, an arithmetic logic unit (ALU), a buffer memory unit, and a touch position detection unit.

The frame memory unit includes an L_frame memory unit and an R_frame memory unit. The L_frame memory unit is configured to store the first digital sensing data, and the R_frame memory unit is configured to store the second digital sensing data. The ALU can include a first L_ALU and a first R_ALU. The first L_ALU is configured to sum each of the first digital sensing data stored in the L_frame memory unit and to output the first summing result of the first digital sensing data. The first R_ALU is configured to sum each of the second digital sensing data stored in the R_frame memory unit and to output the second summing result of the second digital sensing data. The buffer memory unit can include an L_buffer memory unit configured to store the first summing result and an R_buffer memory unit configured to store the second summing result. The touch position detection unit can be configured to determine the one touch position based on the first and second summing results stored in the buffer memory unit.

The L_frame memory unit can include first through third L_frame memories and the R_frame memory unit can include first through third R_frame memories.

The first L_ALU can be configured to sum each of the first digital sensing data stored in the first through third L_frame memories, and the first R_ALU can be configured to sum each of the first digital sensing data stored in the first through third R_frame memories.

The L_buffer memory unit can include first through seventh L_buffer memories, and the R_buffer memory unit can include first through seventh R_buffer memories. Each of the L_buffer and R_buffer memories can be configured to store each sum of the first and second digital sensing data corresponding to (I)th frame, (I+1)th frame and (I+2)th frame, wherein I is a natural number between one and seven.

The touch position detection unit can include an L_touch event detection unit configured to determine whether a first touch event occurred in the first screen region based on the first summing result, an L_touch position detection unit configured to determine a first coordinate in the first screen region of a place where the first touch event occurred, an R_touch event detection unit configured to determines whether a second touch event occurred in the second screen region based on the first summing result, an R_touch position detection unit configured to determine a second coordinate of the place where the second touch event occurred in the second screen region, a final touch event detection unit configured to determine one touch event from the first and second touch events that occurred in the first and second screen regions based on output signals of the L_touch and R_touch event detection units, and a final position detection unit configured to determine the one touch position for the one touch event based on output signals of the L_touch and R_touch position detection units.

The L_touch event detection unit can include a second L_ALU and an L_storing unit. The second L_ALU can be configured to output first respective absolute values of a summing result of the first digital sensing data stored in the first L_buffer memory subtracted respectively from the summing results of the first digital sensing data stored in the second through seventh L_buffer memories. The L_storing unit can be configured to compare the first respective absolute values with a stored first previous maximum value, and to store an L_maximum value as the maximum value of the first respective absolute values. The R_touch event detection unit can include a second R_ALU and an R_storing unit. The second R_ALU can be configured to output second respective absolute values of a summing result of the second digital sensing data stored in the first R_buffer memory subtracted respectively from the summing results of the second digital sensing data stored in the second through seventh R_buffer memories. The R_storing unit can be configured to compare the second respective absolute values with a stored second previous maximum value, and to store an R_maximum value as the maximum value of the second respective absolute values.

The L_storing unit can include an L_comparison unit, a first L_multiplexer and an L_maximum register. The L_comparison unit can be configured to compare the first respective absolute values with the first previous maximum value, and output an L_selection signal. The first L_multiplexer configured to output the largest one of the first respective absolute values and the first previous maximum value. The L_maximum register configured to store an output of the first L_multiplexer. The R_storing unit can include an R_comparison, a first R_multiplexer, and an R_maximum register. The R_comparison unit can be configured to compare the second respective absolute values with the second previous maximum value, and output an R_selection signal. The first R_multiplexer can be configured to output the largest one of the second respective absolute values and the second previous maximum value. The R_maximum register can be configured to store an output of the first R_multiplexer.

The L_touch position detection unit can include a second L_multiplexer configured to select one of a first position signal and the stored first previous maximum position value in response to the L_selection signal, the first position signal representing a position of the first screen region, and an L_position register configured to store an output of the second L_multiplexer. The R_touch position detection unit can include a second R_multiplexer configured to select one of a second position signal and the stored second previous maximum position value in response to the R_selection signal, the second position signal representing a position of the second screen region, and an R_position register configured to store an output of the second R_multiplexer.

The final touch event detection unit can include a first final comparison unit configured to output a final selection signal by comparing the outputs of the L_maximum register and the R_maximum register, a final multiplexer configured to output one of the outputs of the L_maximum register and the R_maximum register in response to the final selection signal, a second final comparison unit configured to output the bigger one of an output of the final multiplexer and a predefined threshold value and a maximum register configured to store an output of the second final comparison unit.

Whether one of the touch events occurred in the touch screen panel can be determined based on the threshold value.

The final position detection unit can include a final position multiplexer configured to select one of outputs of the L_position register and the R_position register, and a position register configured to store an output of the final position multiplexer.

In accordance with another aspect of the present invention, provided is a multiple touch screen display apparatus includes a touch screen panel, a driver circuit unit, and a multiple controller. The touch screen panel includes a plurality of screen regions, and respectively provides a plurality of analog sensing signals when respective touch events occur in the plurality of screen regions. The driver circuit unit includes a plurality of driver circuits configured to respectively convert the plurality of analog sensing signals to a corresponding plurality of digital sensing signals. The multiple controller is configured to determine one touch position of one of the touch events in the touch screen panel based on the plurality of digital sensing signals.

Each of the plurality of analog sensing signals can correspond to a voltage value of a position where the touch events occur.

The touch screen panel can be configured to provide the plurality of analog sensing signals by a frame unit.

In accordance with yet another aspect of the present invention, provided is a method for driving a touch screen display apparatus. The method includes receiving first and second analog sensing signals from a touch screen panel, which includes first and second screen regions, when respective touch events occur in the first and second screen regions. In addition, the method includes converting the first and second sensing signals to first and second digital sensing data. And the method includes determining one touch position of one of the touch events in the touch screen panel based on the first and second digital sensing signals.

The first and second analog sensing signals can correspond to a voltage value of a position where the touch events occur.

The first and second analog sensing signals can be provided from the touch screen panel by the frame unit.

Determining the one touch position can include storing the first digital sensing data in an L_frame memory unit, storing the second digital sensing data in an R_frame memory unit, summing each of the first digital sensing data stored in the L_frame memory unit to output a first summing result of the first digital sensing data, summing each of the second digital sensing data stored in the R_frame memory unit to output a second summing result of the second digital sensing data, and determining the one touch position based on the first and second summing results.

The L_frame memory unit can include first through third L_frame memories and the R_frame memory can include first through third R_frame memories.

The L_buffer memory unit can include first through seventh L_buffer memories, and the R_buffer memory can include first through seventh R_buffer memories, and the method can further comprise storing in each of the L_buffer and R_buffer memories each sum of the first and second digital sensing data corresponding to (I) th frame, (I+1)th frame and (I+2)th frame, wherein I is a natural number between one and seven.

Determining the final touch position can include outputting first respective absolute values of a summing result of the first digital sensing data stored in the first L_buffer memory subtracted respectively from summing result of the first digital sensing data stored in the second through seventh L_buffer memories, comparing the first respective absolute values with a stored first previous maximum value and storing an L_maximum value as the maximum value of the first respective absolute values, outputting second respective absolute values of a summing result of the second digital sensing data stored in the first R_buffer memory subtracted respectively from summing result of the second digital sensing data stored in the second through seventh R_buffer memories, comparing the second respective absolute values with a second previous maximum value and storing an R_maximum value as the maximum value of the second respective absolute values, comparing the L_maximum value and the R_maximum value and outputting a first bigger value as the larger of the L_maximum value and the R_maximum, and comparing the first bigger value with a predefined threshold value and outputting a second bigger value as the larger of the first bigger value and the threshold value.

Determining whether the touch event occurred in the touch screen panel can be based on the threshold value.

Therefore, in accordance with aspects of the present invention, calculation time can be reduced because of the parallel-processing and the power consumption can be reduced because the touch position is detected in the divided screen regions.

### BRIEF DESCRIPTION OF THE DRAWINGS

FIG. 1 is a block diagram illustrating an example embodiment of a touch screen display apparatus according to an aspect of the present invention.

FIG. 2 is a block diagram illustrating an embodiment of an architecture of the hybrid touch screen panel controller in FIG. 1.

FIG. 3 illustrates an embodiment of a first digital sensing data DSD1 stored in an L_frame memory unit of FIG. 2.

FIG. 4 illustrates data stored in an L_buffer memory unit of FIG. 2.

FIG. 5 is a block diagram illustrating an embodiment of a touch position detection unit of FIG. 2.

FIG. 6 illustrates data calculated in a second L_ALU in FIG. 5.

FIG. 7 is a block diagram illustrating an embodiment of a final touch event detection unit of FIG. 5.

FIG. 8 is a block diagram illustrating an embodiment of a multiple touch screen display apparatus according to an aspect of the present invention.

### DESCRIPTION OF THE EMBODIMENTS

Hereinafter, aspects of the present invention will be described by explaining illustrative embodiments in accordance therewith, with reference to the attached drawings. The present invention can, however, be embodied in many different forms and should not be construed as limited to the embodiments set forth herein. While describing these embodiments, detailed descriptions of well-known items, functions, or configurations are typically omitted for conciseness. Like reference numerals refer to like elements throughout this application.

It will be understood that, although the terms first, second, etc. are be used herein to describe various elements, these elements should not be limited by these terms. These terms are used to distinguish one element from another. For example, a first element could be termed a second element, and, similarly, a second element could be termed a first element, without departing from the scope of the present invention. As used herein, the term “and/or” includes any and all combinations of one or more of the associated listed items.

It will be understood that when an element is referred to as being “connected” or “coupled” to another element, it can be directly connected or coupled to the other element or intervening elements can be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is for the purpose of describing particular embodiments and is not intended to be limiting of the invention. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

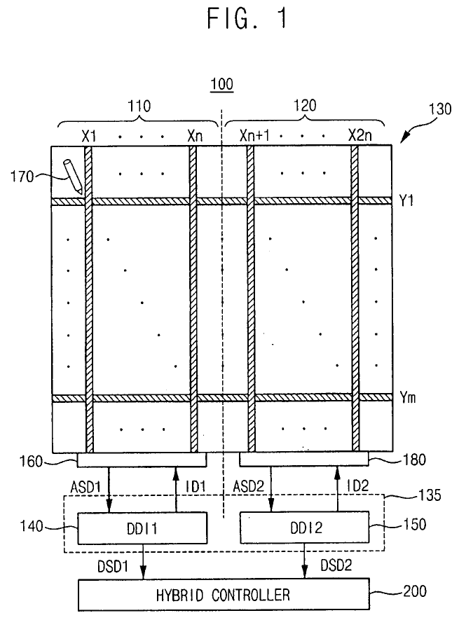

FIG. 1 is a block diagram illustrating an example embodiment of a touch screen display apparatus according to an example embodiment of the present invention.

Referring to FIG. 1, a touch screen display apparatus 100 includes a touch screen panel 130, a driver circuit unit 135 including a first driver circuit 140 and a second driver circuit 150, and a hybrid touch screen panel controller 200.

The touch screen panel 130 includes a first panel having a common electrode and a second panel having a pixel electrode. Liquid crystal is injected between the first and second panels. An image signal is displayed by controlling an electric field applied to the liquid crystal and controlling an amount of light passing through the panels. The touch screen panel 130 includes a first screen region 110 and a second screen region 120.

Is A plurality of first sensors X1 to X2n are arranged with a regular interval in a row direction and a plurality of second sensors Y1 to Ym are arranged with a regular interval in a column direction in the touch screen panel 130. A first plurality of first sensors X1 to Xn are arranged in the first screen region 110 and a second plurality of first sensors Xn+1 to X2n are arranged in the second screen region 120. The first sensors X1 to X2n and the second sensors Y1 to Ym detect a position where a pen 170 or a finger presses. The first sensors X1 to Xn and the second sensors Y1 to Ym in the first screen region transmit first analog sensing signals ASD1 having analog voltage values to the first driver circuit 140 by a frame unit 160. The second sensors Xn+1 to X2n and the corresponding second sensors Y1 to Ym in the second screen region 120 transmit second analog sensing signals ASD2 having analog voltage values to the second driver circuit 150 by a frame unit 180. Frame units 160 and 180 can collectively be referred to as the frame unit.

The first and second driver circuits 140 and 150 provide image data ID1 and ID2 to the touch screen panel 130. The first and second driver circuits 140 and 150 receive the first and second analog sensing signals ASD1 and ASD2 and convert the first and second analog sensing signals ASD1 and ASD2 to first and second digital sensing data DSD1 and DSD2, respectively. The first and second driver circuits 140 and 150 provide the first and second digital sensing data DSD1 and DSD2 to the hybrid touch screen panel controller 200.

The hybrid touch screen panel controller 200 determines one touch event based on the first and second digital sensing signals DSD1 and DSD2 and determines a touch position where the one touch event occurs.

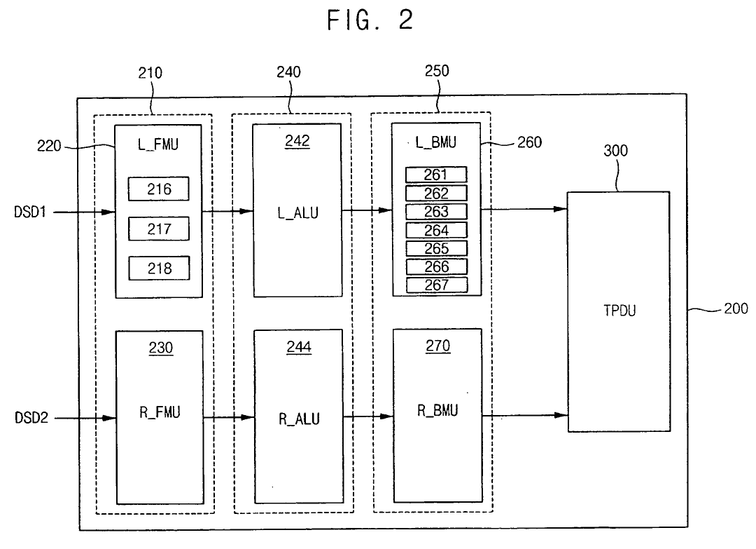

FIG. 2 is a block diagram illustrating an embodiment of an architecture of the is hybrid touch screen panel controller 200 in FIG. 1.

Referring to FIG. 2, the hybrid touch screen panel controller 200 includes a frame memory unit 210, an arithmetic logic unit (ALU) 240, a buffer memory unit 250, and a touch position detection unit 300.

The frame memory unit 210 includes an L_frame memory unit 220 and an R_frame memory unit 230. The L_frame memory unit 220 includes first, second, and third L_frame memories 216, 217, and 218. The R_frame memory unit 230 has the same configuration as the L_frame memory unit 220. The L_frame memory unit 220 stores the first digital sensing signal from the first driver circuit 140, received by the frame memory unit 210. For example, the first L_frame memory 216 stores a first digital sensing signal DSD1 that corresponds to digital values converted from the analog voltages detected by the sensors X1 to Xn and Y1 to Ym in the first screen region 110 for a first frame. The first R_frame memory (not illustrated) stores a second digital sensing signal DSD2 that corresponds to digital values converted from the analog voltages detected by the sensors Xn+1 to X2n and Y1 to Ym in the second screen region 120 for a first frame.

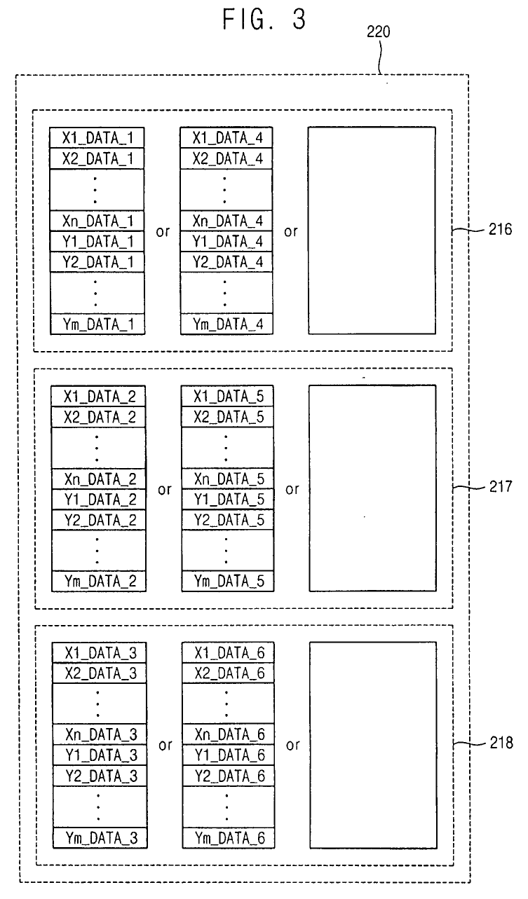

FIG. 3 illustrates an embodiment of first digital sensing data DSD1 stored in the L_frame memory unit 220 of FIG. 2.

Referring to FIG. 3, the first L_frame memory 216 stores all of first N values X1_DATA_1 to Xn_DATA_1 detected in the first sensors X1 to Xn and first M values Y1_DATA_1 to Ym_DATA_1 detected by the second sensors Y1 to Ym for the first frame. Similarly, the second L_frame memory 217 stores all of second N values X1_DATA_2 to Xn_DATA_2 detected in the first sensors X1 to Xn and second M values Y1_DATA_2 to Ym_DATA_2 detected in the second sensors Y1 to Ym for the second frame. The third L_frame memory 218 stores all of third N values X1_DATA_3 to Xn_DATA_3 detected in the first sensors X1 to Xn and second M values Y1_DATA_3 to Ym_DATA_3 detected in the second sensors Y1 to Ym for the third frame. The R_frame memory unit 230 stores the second digital sensing data DSD2 detected by the first sensors Xn+1 to X2n and the second sensors Y1 to Ym.

When the first digital sensing data DSD1 for the first, second, and third frames are stored in the L_frame memory unit 220, the first digital sensing data DSD1 for a fourth frame are stored in the first L_frame memory 216, and first digital sensing data DSD1 for fifth and sixth frames are stored in the second L_frame memory 217 and in the third L_frame memory 218, respectively. Similarly, when the first digital sensing data DSD1 for the fourth, fifth, and sixth frames are stored in the L_frame memory unit 220, the first digital sensing data DSD1 for a seventh frame are stored in the first L_frame memory 216, and first digital sensing data DSD1 for eighth and ninth frames are stored in the second L_frame memory 217 and in the third L_frame memory 218, respectively. While the first digital sensing data DSD1 are stored in the L_frame memory unit 220, the second digital sensing data DSD2 are simultaneously stored in the R_frame memory unit 230 in the same manner.

Referring also to FIG. 2, a first L_ALU 242 sums each of the first digital sensing data DSD1 stored in the first through third L_frame memories 216, 217 and 218 and outputs a first summing result of the first digital sensing data DSD1. For example, the first L_ALU 242 sums data X1_DATA_1 detected in the first row sensor X1 for the first frame, data X2_DATA_2 detected in the first row sensor X1 for the second frame, and data X3_DATA_3 detected in the first row sensor X1 for the third frame, and outputs the summing result Sum_X1_1. That is, the first L_ALU 242 sums data detected in each of the row and column sensors of the touch screen panel 130 for the first, second and third frames, and outputs the summing results Sum_X1_1 to Sum_Xn_1 and Sum_Y1_1 to Sum_Ym_1 to the L_buffer memory unit 260. The first R_ALU 244 sums the data detected in each of the row and column sensors of the touch screen panel 130 for the first, second, and third frames, and outputs the summing results Sum_Xn+1_1 to Sum_X2n_1 and Sum_Y_1 to Sum_Ym_1 to the R_buffer memory unit 270 in parallel with operation of the first L_ALU 242.

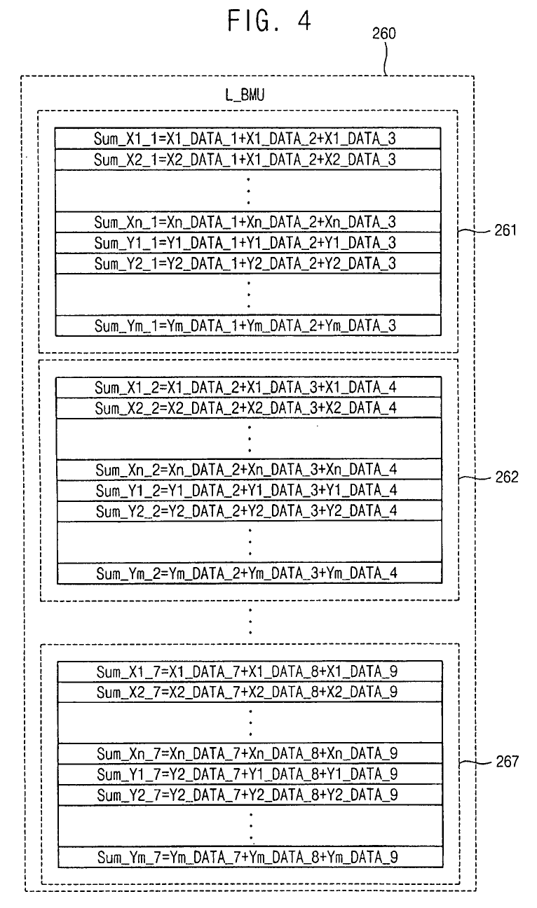

FIG. 4 illustrates data stored in the L_buffer memory unit 260 of FIG. 2.

Referring to FIG. 4, the L_buffer memory unit 260 includes first through seventh L_buffer memory 261, 262, . . . , 267.

The first L_buffer memory 261 stores the summing results Sum_X1_1 to Sum_Xn_1 and Sum_Y1_1 to Sum_Ym_1 for the first, second, and third frames. The second L_buffer memory 262 stores the summing results Sum_X1_2 to Sum_Xn_2 and Sum_Y1_2 to Sum_Ym_2 for the second, third, and fourth frames. Similarly, the third through sixth L_buffer memories store corresponding summing results. And the seventh buffer memory 267 stores the summing result Sum_X1_7 to Sum_Xn_7 and Sum_Y1_7 to Sum_Ym_7 for the seventh, eighth, and ninth frames.

Similarly, the R_buffer memory unit 270 stores each of the summing result from Sum_Xn+1_1 to Sum_X2n−1 and Sum_Y11 to Sum_Ym_1 for the first, second, and third frames to Sum_Xn+1_7 to Sum_X2n_7 and Sum_Y1_7 to Sum_Ym_7 for the seventh, eighth, and ninth frames, in parallel with operation of the L_buffer memory 260.

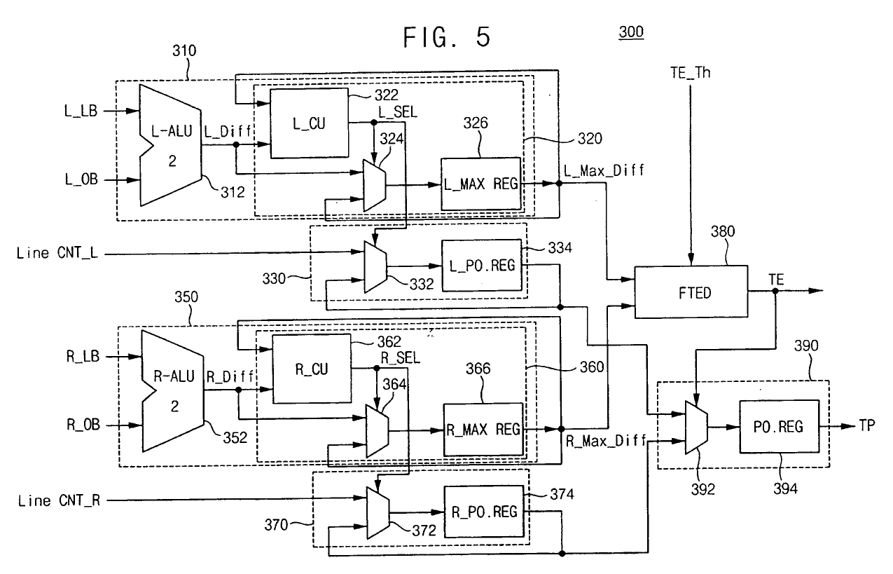

FIG. 5 is a block diagram illustrating an embodiment of the touch position detection unit 300 of FIG. 2.

Referring to FIG. 5, the touch position detection unit 300 includes an L_touch event detection unit 310, an L_touch position detection unit 330, an R_touch event detection unit 350, an R_touch position detection unit 370, a final touch event detection unit 380, and a final position detection unit 390.

The L_touch event detection unit 310 determines whether the touch event occurs in the first screen region 110 based on the first summing result stored in the L_buffer memory unit 260. The L_touch position detection unit 330 determines a first coordinate corresponding to the place where the touch event occurs in the first screen region 110.

The R_touch event detection unit 350 determines whether the touch event occurs in the second screen region 120 based on the second summing result stored in the R_buffer memory unit 270. The R_touch position detection 370 unit determines a second coordinate corresponding to the place where the touch event occurs in the second screen region 120.

The final touch event detection unit 380 determines whether a touch event occurred in the first or second screen regions 110 and 120 based on output signals of the L_touch and R_touch event detection units 310 and 350. The final position detection unit 390 determines the corresponding touch position based on output signals of the L_touch and R_touch position detection units 330 and 370.

The L_touch event detection unit 310 includes a second L_ALU 312 and an L_storing unit 320. The L_storing unit 320 includes an L_comparison unit 322, a first L_multiplexer 324, and an L_maximum register 326. The L_touch position detection unit 330 includes a second L_multiplexer 332 and an L_position register 334.

The R_touch event detection unit 350 includes a second R_ALU 352 and an R_storing unit 360. The R_storing unit 360 includes an R_comparison unit 362, a first R_multiplexer 364, and an R_maximum register 366. The R_touch position detection unit 370 includes a second R_multiplexer 372 and an R_position register 374.

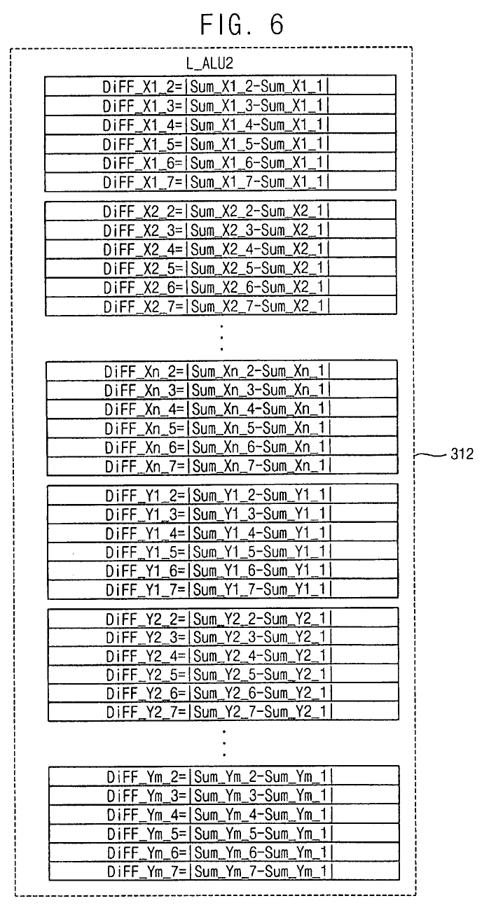

FIG. 6 illustrates data calculated in the second L_ALU 312 in FIG. 5.

Referring to FIG. 6, the second L_ALU 312 outputs first respective absolute values of a summing result L_OB of the first digital sensing data stored in the first L_buffer memory 261 subtracted respectively from summing results L_LB of the first digital sensing data stored in the second through seventh L_buffer memories 262, 263, 264, 265, 266, and 267. The second L_ALU 312 detects the touch event in the first screen region 110 by calculating absolute values of the summing result L_OB of the first digital sensing data stored in the first L_buffer memory 261 subtracted respectively from summing results L_LB of the first digital sensing data stored in the second through seventh L_buffer memories 262, 263, 264, 265, 266, and 267, and thus increasing and decreasing components of the first digital sensing data is included.

The L_comparison unit 322 compares the respective absolute values L_Diff from the second L_ALU 312 with the previous maximum value L_Max_Diff, and outputs an L_selection signal L_SEL. The first L_multiplexer 324 outputs the bigger one of the respective absolute values L_Diff and the first previous maximum value L_Max_Diff in response to the L_selection signal L_SEL. The L_maximum register 326 stores an output of the first L_multiplexer 324.

The second L_multiplexer 332 selects a bigger one of a first position signal L_LINE_CNT, indicating a position of the first screen region 110, and a first previous maximum position value that is stored already in the L_position register 334 in response to the L_selection signal L_SEL. The L_position register 334 stores an output of the second L_multiplexer 332.

Operations of the second R_ALU 352, the R_comparison unit 362, the first R_multiplexer 364, the second R_multiplexer 372, the R_maximum register 366, and the R_position register 347 are substantially identical to operations of the second L_ALU 312, the L_comparison unit 322, the first L_multiplexer 324, the second L_multiplexer 332, the L_maximum register 326, and the L_position register 334, respectively. The R_comparison unit 362 outputs the R_selection signal R_SEL, and the R_maximum register 366 stores an output of the first R_multiplexer 364.

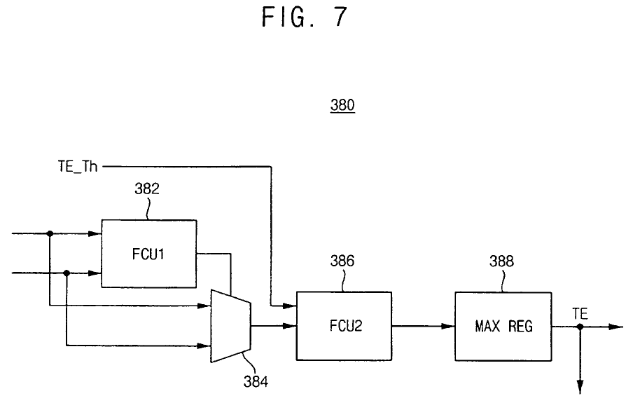

FIG. 7 is a block diagram illustrating the final touch event detection unit 380 of FIG. 5 in detail.

Referring to FIG. 7, an embodiment of the final touch event detection unit 380 is shown, which includes a first final comparison unit 382, a final multiplexer 384, a second final comparison unit 386, and maximum register 388.

The first final comparison unit 382 compares the outputs L_Max_Diff and R_Max_Diff of the L_maximum register 326 and the R_maximum register 366 and outputs a final selection signal. The final multiplexer 384 outputs a bigger one of the outputs L_Max_Diff and R_Max_Diff of the L_maximum register 326 and the R_maximum register 366 in response to the final selection signal. The second final comparison unit 386 compares the output of the final multiplexer 384 and a threshold value TE_Th that is predefined and outputs the bigger one of the output of the final multiplexer 384 and the threshold value TE_Th. Whether the touch event occurred in the touch screen panel 130 is determined based on the threshold value TE_Th. When the output of the final multiplexer 384 is greater than the threshold value TE_Th, a touch event occurred in the touch screen panel 130. The maximum register 388 stores output of the final comparison unit 386.

Referring back to FIG. 5, the final touch position detection unit 390 includes a final position multiplexer 392 and a position register 394.

The final position multiplexer 392 selects one of the outputs of the L_position register 334 and the R_position register 374 in response to the output of the maximum register 388. The position register 394 stores output of the final position multiplexer 392. The output of the final position multiplexer 392 stored in the position register 394 denotes a coordinate of the touch position where a touch event occurred.

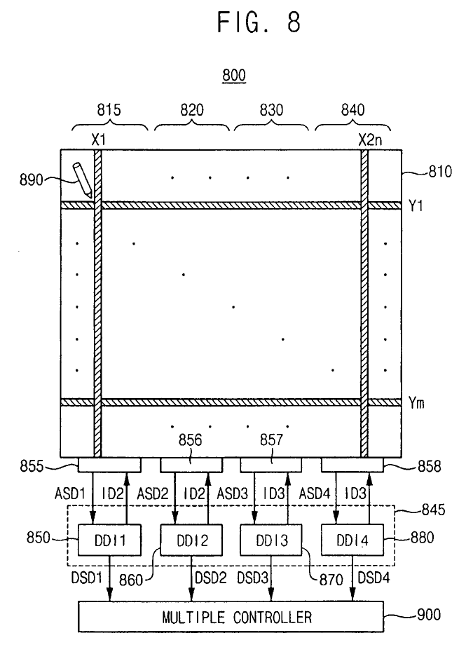

FIG. 8 is a block diagram illustrating an example embodiment of a multiple touch screen display apparatus according to another aspect of the present invention.

Referring to FIG. 8, a multiple touch screen display apparatus 800 includes a touch screen panel 810 that includes a plurality of screen regions 815, 820, 830, and 840, a driver circuit unit 845 including a plurality of driver circuits 850, 860, 870, and 880, and a multiple controller 900.

A plurality of first sensors X1 to X2n are arranged with a regular interval in a row direction and a plurality of second sensors Y1 to Ym are arranged with a regular interval in a column direction in the touch screen panel 810. The first sensors X1 to X2n and the second sensors Y1 to Ym detect a position where the pen 890 or a finger presses. The first sensors X1 to X2n and the second sensors Y1 to Ym transmit first through fourth analog sensing signals ASD1 through ASD4 converted into voltage values to the first through fourth driver circuits 860, 870, 880, and 890 by the frame units 855 through 858, respectively, which can be collectively referred to as the frame unit. The driver circuits 860, 870, 880, and 890 receive the first through fourth analog sensing signals ASD1 through ASD4 and convert them to first through fourth digital sensing data DSD1 through DSD4, respectively, and provide the first through fourth digital sensing data DSD1 through DSD4 to the multiple controller 900. The multiple controller 900 processes in parallel the first through fourth digital sensing data DSD1 through DSD4, and detect a touch event and a touch position where the touch event occurs.

As mentioned above, the touch screen display apparatus, the multiple touch screen display apparatus, and the method of driving the touch screen display apparatus according to example embodiments of the present invention detect the touch position by parallel-processing a plurality of digital sensing data converted by a plurality of driver circuits. Therefore, calculation time can be reduced because of the parallel-processing and the power consumption can be reduced, since the touch position is detected in the divided screen regions. In addition, the touch screen display apparatus, the multiple touch screen display apparatus, and the method of driving a touch screen display apparatus according to example embodiments in accordance with the present invention can be applicable when the panel size or the resolution changes.

While the example embodiments of the present invention and their advantages have been described in detail, it should be understood that various changes, substitutions and alterations can be made herein without departing from the scope of the invention. It is intended by the following claims to claim that which is literally described and all equivalents thereto, including all modifications and variations that fall within the scope of each claim.

What is claimed is:

1. A touch screen display apparatus comprising:
a touch screen panel that includes first and second screen regions, configured to respectively provide first and second analog sensing signals when respective touch events occur in the first and second screen regions;
a driver circuit unit including first and second driver circuits configured to respectively convert the first and second analog sensing signals to first and second digital sensing data; and
a hybrid touch screen panel controller configured to determine one touch position of one of the touch events in the touch screen panel based on the first and second digital sensing data.

2. The touch screen display apparatus of claim 1, wherein the first and second analog sensing signals correspond to a voltage value associated with respective a positions in the touch screen panel where the touch events occurred.

3. The touch screen display apparatus of claim 1, wherein the touch screen panel includes at least one frame unit configured to provide the first and second analog sensing signals to the driver circuit unit.

4. The touch screen display apparatus of claim 3, wherein the hybrid touch screen panel controller comprises:
a frame memory unit including an L_frame memory unit and an R_frame memory unit, the L_frame memory unit configured to store the first digital sensing data, the R_frame memory unit configured to store the second digital sensing data;
an arithmetic logic unit (ALU) including a first L_ALU and a first R_ALU, the first L_ALU configured to sum each of the first digital sensing data stored in the L_frame memory unit and to output the first summing result of the first digital sensing data, the first R_ALU configured to sum each of the second digital sensing data stored in the R_frame memory unit and to output the second summing result of the second digital sensing data;
a buffer memory unit including an L_buffer memory unit configured to store the first summing result and an R_buffer memory unit configured to store the second summing result; and
a touch position detection unit configured to determine the one touch position based on the first and second summing results stored in the buffer memory unit.

5. The touch screen display apparatus of claim 4, wherein the L_frame memory unit includes first through third L_frame memories and the R_frame memory unit includes first through third R_frame memories.

6. The touch screen display apparatus of claim 5, wherein the first L_ALU is configured to sum each of the first digital sensing data stored in the first through third L_frame memories, and the first R_ALU is configured to sum each of the first digital sensing data stored in the first through third R_frame memories.

7. The touch screen display apparatus of claim 6, wherein the L_buffer memory unit includes first through seventh L_buffer memories, and the R_buffer memory unit includes first through seventh R_buffer memories, and wherein each of the L_buffer and R_buffer memories is configured to store each sum of the first and second digital sensing data corresponding to (I)th frame, (I+1)th frame and (I+2)th frame, wherein I is a natural number between one and seven.

8. The touch screen display apparatus of claim 7, wherein the touch position detection unit comprises:
an L_touch event detection unit configured to determine whether a first touch event occurred in the first screen region based on the first summing result;
an L_touch position detection unit configured to determine a first coordinate in the first screen region of a place where the first touch event occurred;
an R_touch event detection unit configured to determine whether a second touch event occurred in the second screen region based on the first summing result;
an R_touch position detection unit configured to determine a second coordinate in the second screen region of a place where the second touch event occurred;
a final touch event detection unit configured to determine one touch event from the first and second touch events that occurred in the first and second screen regions based on output signals of the L_touch and R_touch event detection units; and
a final position detection unit configured to determine the touch position for the one touch event based on output signals of the L_touch and R_touch position detection units.

9. The touch screen display apparatus of claim 8,
wherein the L_touch event detection unit comprises:
a second L_ALU configured to output first respective absolute values of a summing result of the first digital sensing data stored in the first L_buffer memory subtracted respectively from the summing results of the first digital sensing data stored in the second through seventh L_buffer memories; and
an L_storing unit configured to compare the first respective absolute values with a stored first previous maximum value, and to store an L_maximum value as the maximum value of the first respective absolute values, and
wherein the R_touch event detection unit comprises:
a second R_ALU configured to output second respective absolute values of a summing result of the second digital sensing data stored in the first R_buffer memory subtracted respectively from the summing results of the second digital sensing data stored in the second through seventh R_buffer memories; and
an R_storing unit configured to compare the second respective absolute values with a stored second previous maximum value, and to store an R_maximum value as the maximum value of the second respective absolute values.

10. The touch screen display apparatus of claim 9,
wherein the L_storing unit comprises:
an L_comparison unit configured to compare each of the first respective absolute values with the first previous maximum value, and output an L_selection signal;
a first L_multiplexer configured to output the largest one of the first respective absolute values and the first previous maximum value; and
an L_maximum register configured to store an output of the first L_multiplexer, and
wherein the R_storing unit comprises:
an R_comparison unit configured to compare the second respective absolute values with the second previous maximum value, and output an R_selection signal;
a first R_multiplexer configured to output the largest one of the second respective absolute values and the second previous maximum value; and
an R_maximum register configured to store an output of the first R_multiplexer.

11. The touch screen display apparatus of claim 10,
wherein the L_touch position detection unit comprises:
a second L_multiplexer configured to select one of a first position signal and the stored first previous maximum position value in response to the L_selection signal, the first position signal representing a position of the first screen region; and
an L_position register configured to store an output of the second L_multiplexer, and
wherein the R_touch position detection unit comprises:
a second R_multiplexer configured to select one of a second position signal and the stored second previous maximum position value in response to the R_selection signal, the second position signal representing a position of the second screen region; and
an R_position register configured to store an output of the second R_multiplexer.

12. The touch screen display apparatus of claim 10, wherein the final touch event detection unit comprises:
a first final comparison unit configured to output a final selection signal by comparing the outputs of the L_maximum register and the R_maximum register;
a final multiplexer configured to output one of the outputs of the L_maximum register and the R_maximum register in response to the final selection signal;
a second final comparison unit configured to output the bigger one of an output of the final multiplexer and a predefined threshold value; and
a maximum register configured to store an output of the second final comparison unit.

13. The touch screen display apparatus of claim 12, wherein whether one of the touch events occurred in the touch screen panel is determined based on the threshold value.

14. The touch screen display apparatus of claim 12, wherein the final position detection unit comprises:
a final position multiplexer configured to select one of outputs of the L_position register and the R_position register; and
a position register configured to store an output of the final position multiplexer.

15. A multiple touch screen display apparatus comprising:
a touch screen panel including a plurality of screen regions, configured to respectively provide a plurality of analog sensing signals when respective touch events occur in the plurality of screen regions;
a driver circuit unit including a plurality of driver circuits configured to respectively convert the plurality of analog sensing signals to a corresponding plurality of digital sensing signals; and
a multiple controller configured to determine one touch position of one of the touch events in the touch screen panel based on the plurality of digital sensing signals.

16. The multiple touch screen display apparatus of claim 15, wherein each of the plurality of analog sensing signals corresponds to a voltage value of a position where the touch events occur.

17. The multiple touch screen display apparatus of claim 15, wherein the touch screen panel is configured to provide the plurality of analog sensing signals by a frame unit.

18. A method of driving a touch screen display apparatus, the method comprising:
receiving first and second analog sensing signals from a touch screen panel, which includes first and second screen regions, when respective touch events occur in the first and second screen regions;
converting the first and second sensing signals to first and second digital sensing signals; and
determining one touch position of one of the touch events in the touch screen panel based on the first and second digital sensing signals.

19. The method of claim 18, wherein the first and second analog sensing signals correspond to a voltage value of a position where the touch events occur.

20. The method of claim 18, further comprising providing the first and second analog sensing signals from the touch screen panel by a frame unit.

21. The method of claim 20, wherein determining the one touch position comprises:
storing the first digital sensing data in an L_frame memory unit;
storing the second digital sensing data in an R_frame memory unit;
summing each of the first digital sensing data stored in the L_frame memory unit to output a first summing result of the first digital sensing data;
summing each of the second digital sensing data stored in the R_frame memory unit to output a second summing result of the second digital sensing data; and
determining the one touch position based on the first and second summing results.

22. The method of claim 21, wherein the L_frame memory unit includes first through third L_frame memories and the R_frame memory unit includes first through third R_frame memories.

23. The method of claim 21, wherein the L_buffer memory includes first through seventh L_buffer memories, and the R_buffer memory includes first through seventh R_buffer memories, the method further comprising:
storing in each of the L_buffer and R_buffer memories each sum of the first and second digital sensing data corresponding to (I)th frame, (I+1)th frame and (I+2)th frame, wherein I is a natural number between one and seven.

24. The method of claim 23, wherein determining the one touch position comprises:
outputting first respective absolute values of a summing result of the first digital sensing data stored in the first L_buffer memory subtracted respectively from summing result of the first digital sensing data stored in the second through seventh L_buffer memories;
comparing the first respective absolute values with a stored first previous maximum value, and storing an L_maximum value as the maximum value of the first respective absolute values;
outputting second respective absolute values of a summing result of the second digital sensing data stored in the first R_buffer memory subtracted respectively from summing result of the second digital sensing data stored in the second through seventh R_buffer memories;
comparing the second respective absolute values with a stored second previous maximum value, and storing an R_maximum value as the maximum value of the second respective absolute values;
comparing the L_maximum value and the R_maximum value and outputting a first bigger value as the larger of the L_maximum value and the R_maximum; and
comparing the first bigger value with a predefined threshold value and outputting a second bigger value as the larger of the first bigger value and the threshold value.

25. The method of claim 24, further comprising determining whether the touch event occurs in the touch screen panel based on the threshold value.
